(19) United States
(12) Patent Application Publication
(10) Pub. No.: US 2003/0100362 A1
(43) Pub. Date: May 29, 2003

(54) System and method for providing incentive to user of a gaming device

(75) Inventors: Stephen Horniak, Doylestown, PA (US); James N. Augeri, North Wales, PA (US); Stephen C. Horniak, North Wales, PA (US)

Correspondence Address: SYNNESTVEDT & LECHNER, LLP, 2600 ARAMARK TOWER, 1101 MARKET STREET, PHILADELPHIA, PA, 191072950

(73) Assignee: Deltronic Labs, Inc., Chalfont, PA (US)

(21) Appl. No.: 10/339,869

(22) Filed: Jan. 10, 2003

Related U.S. Application Data
(63) Continuation of application No. 09/774,947, filed on Jan. 31, 2001, now abandoned.
(60) Provisional application No. 60/179,134, filed on Jan. 31, 2000.

(51) Int. Cl. G06F 19/00

(52) U.S. Cl. 463/25

(57) ABSTRACT

A method and system for providing incentives to the players of a slot machine to continue to use the slot machine. A ticket dispenser capable of being integrally coupled with a slot machine is provided. The ticket dispenser includes a ticket dispensing unit for dispensing tickets, and an interface for controlling the operation of the ticket dispensing unit in response to certain output signals from the slot machine. The interface controls the ticket dispensing unit to dispense tickets according to predefined criteria, e.g., when the number of coins bet equals a predetermined number. The dispensed tickets can then be redeemed for prizes, utilized for additional gambling, and/or used for whatever reward purposes the casino decides.

### RELATED APPLICATION

This patent application claims the benefit of priority based on U.S. Provisional Patent Application No. 60/179,134 filed on Jan. 31, 2000, owned by the same assignee of the present invention and entitled “Method and Apparatus for Providing Incentive to User of a Gaming Device,” which is incorporated fully herein by reference.

### BACKGROUND OF THE INVENTION

1. Field of the Invention

This invention relates to electronic gaming devices, and more particularly to a system and method for providing incentives to the players of slot machines to continue to use the slot machines.

2. Description of the Related Art

Electronic slot machines have been in use for many years. While electronic slot machines come in various configurations, the basic structure and operation of such devices are relatively similar. An example of a typical electronic slot machine is found in U.S. Pat. No. 4,099,722 to Rodesch et al., incorporated fully herein by reference. Electronic slot machines basically comprise a series of counters, sensors, and display devices. The sensors sense the occurrence of particular events such as, for example, the insertion of a coin into the slot machine, the pulling of the slot machine arm and/or the activation of a “bet” or “play” button, the position of mechanical wheels that display gaming indicia (e.g., numbers, pictures of fruit or other symbols, etc. displayed on rotating reels) and the like. The counters count the occurrence of many of the sensed events, including, the number of coins input to the slot machine, the number of activations of the bet/play button and/or slot machine arm, the number of “jackpots” or coins won, etc. The display devices display various conditions such as a display of the dollar amount inserted into the machine, a display of the amount of winnings, a display of the winning combinations, etc. Some of these displays may not be visible to the player, but instead may be visible to a service person or operator of the device upon opening of the machine (e.g., the operator of the machine may wish to track the number of plays that have occurred on the machine since it was last serviced).

In other gaming devices such as video or arcade game devices, a ticket dispensing device may be used to automatically dispense a predetermined number of tickets based upon the score achieved in the video or arcade game. The tickets can then be exchanged for prizes or used to play additional games. One example of such a dispensing device is found in U.S. Pat. No. 4,272,001 to Horniak et al.

In casinos and other locations where slot machines can be found, the odds of winning predominantly favor the casino as opposed to the user of the slot machine device. Accordingly, casinos and other establishments which provide gaming devices for use by customers utilize many techniques to encourage use of the slot machines and thereby increase the earnings of the casino. Free drinks and food are provided to the gamblers; bells and whistles are constantly activated to apprize all of the gamblers of the success of the slot machine users; “slot clubs” are established to reward registered members for frequent use. To assist in this encouragement, gaming apparatuses having incentive-producing means have been developed as illustrated in U.S. Pat. Nos. 5,971,850, 5,909,486, and 5,370,399, all of which are incorporated herein fully by reference.

U.S. Pat. No. 5,909,486 describes a slot club program which provides telephone time to be awarded to a registered slot club member based upon predefined casino-specific rewards criteria, which may include an amount of currency played by the player of the slot machine, an amount of currency the player has won from the slot machine, an amount of time the player has played the slot machine, an amount of currency with which the player started playing the slot machine, or even the number of times the player plays the machine.

A drawback to the method disclosed in U.S. Pat. No. 5,909,486 is that the casino must program and update database information on club members, so that, when a club member inserts his or her card, the appropriate credits can be attributed to the appropriate slot club member. This requires additional computer programming resources and maintenance for the casino, among other problems. Accordingly, it would be desirable to have a simple method and system for providing an incentive to the user of a slot machine to use the machine without requiring pre-registration by the user and constant “membership” updating by the casino.

### SUMMARY OF THE INVENTION

The present invention provides a simple method and apparatus for providing incentives to the players of a slot machine to use the slot machine. According to the present invention, a programmable ticket dispenser capable of being integrally coupled with a slot machine, is provided. The ticket dispenser includes a ticket dispensing unit for dispensing tickets, and an interface for controlling the operation of the ticket dispensing unit in response to certain output signals from the slot machine. The output signals may be, for example, coin-in signals indicating a number of coins that the players insert into the slot machine, coin-bet signals indicating a number of coins that the players bet to play the game of the slot machine, or coin-won signals indicating the number of coins that the players win from playing the game.

The interface in the ticket dispenser monitors the output signals from the slot machine and determines whether or not a predetermined ticket dispensing event has occurred based on the output signals. The predetermined ticket dispensing event may constitute a count of the number of coins inserted, bet or won reaching a predetermined number. Other ticket dispensing events are possible. If such an event has occurred, the interface controls the ticket dispensing unit to dispense tickets. The dispensed tickets can then be redeemed for prizes, utilized for additional gambling, and/or used for whatever reward purposes the casino or other establishments decide.

The ticket dispenser of the present invention utilizes preexisting outputs signals typically generated by conventional electronic slot machines to trigger the dispensing of tickets. Thus, with minimal modification, the ticket dispenser can be coupled easily with any existing slot machine or be manufactured as part of the slot machine, thereby providing a reward dispensing gaming system that is simple, effective, easy to install, convenient to operate, and attractive in appearance.

### BRIEF DESCRIPTION OF THE DRAWINGS

FIG. 1 is an exemplary pictorial representation of a gaming system according to one embodiment of the present invention.

FIG. 2 is a functional block diagram of the gaming system of FIG. 1 according to a preferred embodiment of the present invention.

FIG. 3 is a flowchart illustrating the processing steps of a method of dispensing rewards according to a preferred embodiment of the present invention.

FIG. 4 is a flowchart illustrating the processing steps executed by a computer device of the system in FIG. 2 according to one embodiment of the present invention.

FIG. 5 is a flowchart illustrating the processing steps of a Set-up and Operation (S&O) routine in FIG. 4 according to one embodiment of the present invention.

FIG. 5A is a flowchart illustrating the processing steps of Part A in FIG. 5 according to one embodiment of the present invention.

FIG. 5B is a flowchart illustrating the processing steps of Part B in FIG. 5A according to one embodiment of the present invention.

FIG. 5C is a flowchart illustrating the processing steps of Part C in FIG. 5B according to one embodiment of the present invention.

FIG. 5D is a flowchart illustrating the processing steps of Part D in FIG. 5B according to one embodiment of the present invention.

FIG. 6 is a flowchart illustrating the processing steps of a TDU-ON routine in FIG. 5B according to one embodiment of the present invention.

FIG. 7 is a flowchart illustrating the processing steps of a TDU-OFF routine in FIG. 5C according to one embodiment of the present invention.

FIG. 8 is a flowchart illustrating the processing steps of a Status-CK routine in FIG. 4 according to one embodiment of the present invention.

### DETAILED DESCRIPTION OF THE PREFERRED EMBODIMENTS

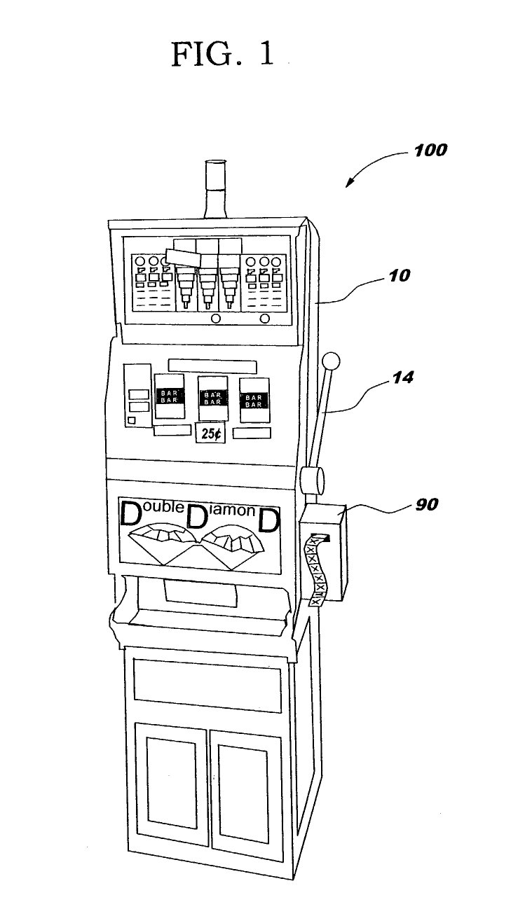

FIG. 1 is an exemplary pictorial representation of a gaming system 100 according to one embodiment of the present invention. As shown in FIG. 1, the gaming system 100 includes a slot machine 10 integrally coupled with a ticket dispenser (TD) 90 for dispensing tickets. The slot machine 10 is a conventional electronic slot machine or other gaming device which allows a player to play a game upon receipt of the player's money or the like and which outputs winning results, typically in coins, to the player when the player wins the game. The slot machine 10 includes an arm 14 for triggering the game operation of the slot machine 10 according to known techniques. Although the TD 90 is shown to be integrally attached to the slot machine 10, the TD 90 may be incorporated inside the slot machine 10 or may be remotely coupled to the slot machine 10.

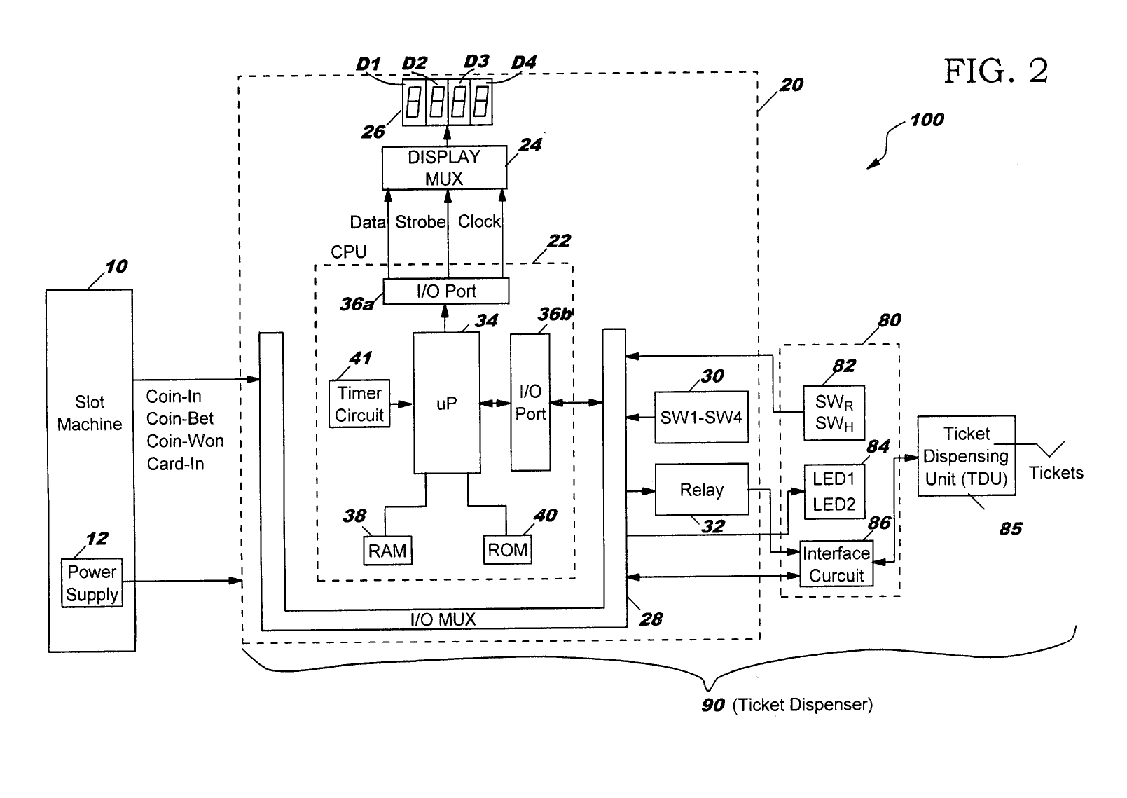

FIG. 2 is a functional block diagram of the gaming system 100 shown in FIG. 1 according to a preferred embodiment of the present invention. As shown in FIG. 2, the slot machine 10 includes power supply 12 for supplying electrical power to the TD 90.

The TD 90 includes a first interface module 20, a second interface module 80, and a ticket dispensing unit (TDU) 85, all operatively connected. Each of the first and second interface modules 20 and 80 can be mounted or implemented on a separate printed circuit board (PCB). In the alternative, both the first and second interface modules 20 and 80 can be implemented on a single PCB.

The first interface module 20 includes a CPU (central processing unit) 22, a display multiplexer/interface 24, a display unit 26 such as a four-digit display, an I/O (input/output) multiplexer/interface 28, a plurality of switches 30 (SW1, SW2, SW3, SW4), and a relay 32, all operatively coupled. The CPU 22 includes a microprocessor 34, at least first and second I/O ports 36a,36b, Random Access Memory (RAM) 38, Read Only Memory (RAM) 40, and a timer/clock circuit 41, all operatively coupled. Although it is not shown for the sake of brevity, the CPU 22 may further include other components that may be needed to implement the operation of the system 100 as known in the art.

The second interface module 80 includes a plurality of switches 82 (e.g., a reset switch SW_{R} and a “help” switch SW_{H} for use in a help mode), a plurality of light emitting diodes 84 (LED1, LED2) or the like, and a TDU interface circuit 86, all operatively coupled. LED1 functions as a “Low Bin” LED indicating when the ticket bin in the TDU 85 is low in tickets, and LED2 functions as a help-mode LED indicating when the system is in a help mode. Unlike other components in the TD 90, these LEDs are visible from the outside of the TD 90 (without having to open the TD 90) so that anyone, including the player, can view the LEDs.

The TDU 85 is a conventional ticket dispensing unit that dispenses tickets according to certain control signals. The TDU 85 typically includes a bin for stacking up tickets to be dispensed, a motor for moving the tickets out from the bin through a ticket slot, and other components that are well known in the art.

The operation and functions of these components in the TD 90 are as follows according to a preferred embodiment of the present invention.

The slot machine 10 outputs to the TD 90 a plurality of signals typically generated by the CPU in the slot machine 10. These signals include, but are not limited to, Coin-In or Coin-Bet signals, Coin-Won signals, and/or Card-In signals. Coin-In signals indicate a number of coins that the players insert into the slot machine 10. Coin-Bet signals indicate a number of coins that the players bet to play the game of the slot machine 10. In some slot machines, Coin-In and Coin-Bet signals are the same in that coins that players insert into the slot machine are treated automatically as coins bet by the players. Coin-Won signals indicate a number of coins that the players win from playing the game of the slot machine 10. Card-In signals indicate the presence of a player tracking card in the slot machine 10. A player tracking card is well known in the art and generally functions like a debit card in that any amount of money that the player bets is automatically deducted from the player's account via the tracking card. Casinos use the tracking cards to keep track of the amount of money that each player bets during a given time period which can be used for accounting and other purposes.

The I/O multiplexer/interface 28 receives the output signals from the slot machine 10. The microprocessor 34 accesses these signals from the I/O multiplexer/interface 28 through the second I/O port 36b. It determines if a predetermined ticket dispensing event has occurred based on these signals and controls the operation of the TDU 85 when such an event occurs. The nature of the predetermined ticket dispensing event is programmed into the CPU 22, typically during a set-up of the system 100. The microprocessor 34 also generates control signals and data signals to the display multiplexer/interface 24 via the first I/O port 36a. The display multiplexer/interface 24 causes the display unit 26 to display the data signals according to the control signals. The display unit 26 can display information such as the total number of tickets in the ticket bin, the total number of tickets dispensed, etc. The display unit 26 is stored inside the TD 90 so that it is not visible to the player of the slot machine 10.

ROM 40 may be used to store any computer programs used by the microprocessor 34. RAM 38 may be used to store any variables that are initialized, changed or otherwise affected by the operation of the system 100. The timer circuit 41 provides clock signals and other timing features as needed by the microprocessor 34. The relay 32 functions as a connector for supplying power to the TDU 85 via the TDU interface circuit 86, and the switches 30 communicate operator inputs to the CPU 22.

In the second interface module 80, the help switch SW_{H} is used in help modes and the reset switch SW_{R} resets count values and other parameters. The LEDs 84 indicate a help mode and other status of the TD 90 to the operator or player, and the TDU interface circuit 86 enables communication between the CPU 22 and the TDU 85.

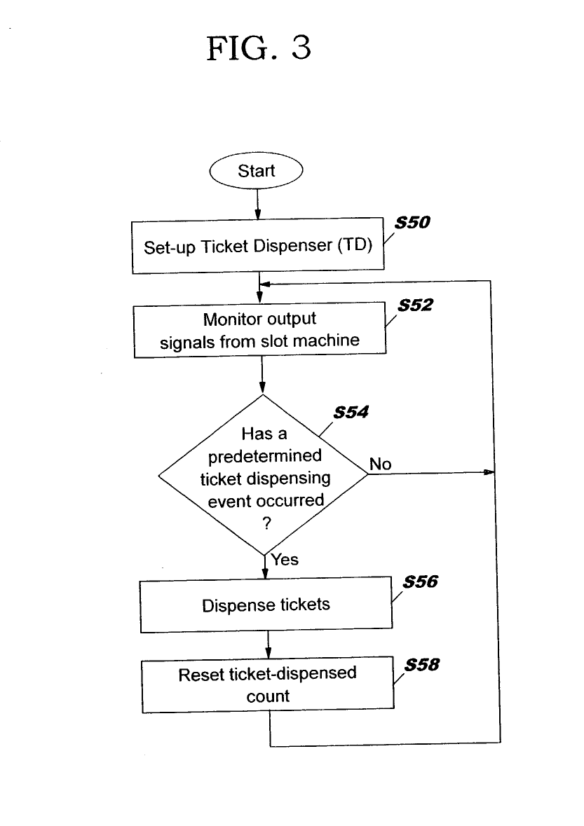

FIG. 3 is a flowchart illustrating the steps involved in a method of providing incentives to the player of a slot machine according to a preferred embodiment of the present invention.

As shown in FIG. 3, as an initial step, the TD 90 in the system 100 is set up by the operator in Step S50. This primarily involves programming the TD 90 to dispense tickets in a manner desired by the operator or casino. To accomplish this, the programmable TD 90 offers a plurality of options and option values which the operator can select to program the TD 90 to function in the desired manner. The operator can press certain switches (e.g., SW2-SW4) and view the selection via the display unit 26 to select or set the options and option values. The set options and option values dictate when the tickets are supposed to be dispensed, i.e., what the predetermined ticket dispensing events are for the current TD 90. The TD 90 is reprogrammable at any time by manipulating the switches SW2-SW4 if the operator desires to change the set-up, options and/or option values.

In Step S52, once the set-up is completed, the TD 90 operates in a normal operation mode and monitors outputs signals (e.g., Coin-In/Coin-Bet, Coin-Won, and/or Card-In signals) from the slot machine 10. Depending on the options and option values set at Step S50, the TD 90 (e.g., CPU 22) determines whether a predetermined ticket dispensing event has occurred based on the output signals from the slot machine 10, in Step S54. If this event has not occurred, then the process returns to Step S52 discussed above. However, if this event has occurred, then the CPU 22 controls the TDU 85 to dispense tickets. The programming of the TD 90 at Step S50 dictates how many tickets are to be dispensed at this time. These tickets are redeemable for prizes, utilized for additional gambling, and/or used for whatever reward purposes the casino or other establishments decide. In one embodiment, these tickets have casino-specific bar codes or other machine-readable codes thereon so that they can be quickly counted when they are being redeemed and cannot be easily duplicated for security and anti-theft reasons.

In Step S58, the ticket-dispensed count value and other count values are reset (e.g., to 0) and the process loops back to Step S52 to monitor the output signals again. These steps are repeated as long as there are no errors or power outage in the system.

In accordance with one embodiment, generally there are four possible ticket dispensing events/modes and they are.

1) Coin-In/Coin-Bet (CI/CB) Non-Random Mode—the total number of coins inserted or bet in the slot machine reaches a predetermined count value;

2) CI/CB Random Mode—the total number of coins inserted or bet in the slot machine reaches a predetermined maximum count value, OR the total number of coins inserted or bet in the slot machine is equal to or greater than a predetermined minimum count value but less than the predetermined maximum count value AND a current random number generated by the TD 90 equals a predetermined comparison value (e.g., 0);

3) Coin-Won (CW) Non-Random Mode—the total number of coins dispensed by the machine as winnings (i.e., coins won by the players) reaches a predetermined count value; and

4) CW Random Mode—the total number of coins dispensed by the machine as winnings reaches a predetermined maximum count value, OR the total number of coins dispensed by the machine as winnings is equal to or greater than a predetermined minimum count value but less than the predetermined maximum count value AND a current random number generated by the TD 90 equals a predetermined comparison value (e.g., 0).

In all these events, the total number of coins inserted, bet or won is not determined based on each player, but is determined cumulatively irrespective of players.

The Non-Random modes allow the tickets to be dispensed if the total number of coins inserted, bet or won equals a certain number. But in the Random modes, an element of randomness is introduced to the ticket dispensing process. Particularly, minimum and maximum count values are set by the operator in an options-setting mode. If the total number of coins inserted, bet or won is equal to or greater than the minimum count value, a random number that the CPU 22 has currently generated is compared with a predetermined comparison value (e.g., 0). CPU 22 is configured to generate a new random number for every certain time duration (e.g., for every 1 ms). Whenever the random number matches the comparison value, then the tickets are dispensed. But if no tickets have been dispensed because the random number has not been equal to the comparison value and the total number of coins inserted, bet or won has reached the maximum count value, then the tickets are also dispensed. The Random modes introduce an element of surprise to the ticket receiving process for the players because the players do not know when the tickets will be dispensed, rendering the game more interesting and motivating the players to continue to play the game.

In some embodiments, a greater number of tickets may be dispensed if the player is playing the slot machine using a player tracking card (i.e., if Card-In signal is active) compared to when the player plays the slot machine without the player tracking card, i.e., just with the coins. This enables the casino to reward players who use the player tracking cards with more tickets than players who do not use such cards

It should be understood that these ticket dispensing events ((1)˜(4) above) can be combined in a variety of different ways to constitute a single ticket dispensing event. For example, events (1) and (3) can be combined such that tickets are dispensed when the total number of tickets inserted/bet equals a predetermined number AND the total number of tickets won equals a predetermined number. Other examples are possible. Furthermore, other ticket dispensing events are possible, e.g., based on time. For instance, the system can be configured to dispense tickets at certain times (e.g., 2:30 pm, 4:41 pm, etc.). These times can be set randomly and can differ on each day. This provides incentives to the players to continue to play the game because the probability of being rewarded with tickets increases as the playing time increases.

A process of setting options and option values for the TD 90 according to one embodiment of the present invention is now described. In accordance with this embodiment, each option is given a single digit number/letter referred to herein as an “option number,” and is associated with a three digit value referred to herein as an “option value.” The option number and the option value are displayed on the display unit 26 while they are being set. If the display unit 26 is a four digit display (FIG. 2), position Dl corresponds to the option number, and positions D2, D3 and D4 correspond to the three-digit option value.

To start the options-setting process, the operator presses the switch SW2 in the first interface module 20. This will cause the TD 90 to enter the options-setting mode. The four-digit display unit 26 will display some number ‘NZYX’ where N=the option number being set, and ZYX=the option value associated with the option number. Since no options have been set, the “NZYX” will be “0000” with “X” digit blinking. Only one digit blinks at a time, and the blinking indicates that the value of the blinking digit is presently being set. In this embodiment, only the digits of the option value (and not the option number) blink, and the blinking of the digits moves from the digit “X” to “Y” to “Z” to “X” and so on. This digit setting procedure is given for purpose of example only and clearly, other examples are possible.

Once the display unit 26 displays an option number and associated option value, the operator can press the switch SW2 again to accept the option value of the displayed option number and to go to the next option number. That is, each time SW2 is pressed, the next option number with the corresponding option value is displayed. Pressing SW2 on the last option number causes the system to exit out of the options-setting mode and to operate in the normal operation mode.

To increment the value of the blinking digit of an option value, the operator presses the switch SW3. Each time SW3 is pressed, the value of the blinking digit is incremented by one. If SW3 is pressed when the blinking digit is at its maximum value (i.e., 1 or 9 depending on the option number), the value of the blinking digit will go to 0 or a starting value.

To accept the value of the blinking digit and to go to the next digit of the option value, the switch SW4 is used. If SW4 is pressed when the digit “Z” of an option value is blinking, this causes the digit “X” of the option value to start blinking.

In one embodiment, when the display unit 26 displays the last option number and the associated option value and the operator accepts them by pressing the switch SW2, the system is configured to exit out of the options-setting mode. In another embodiment, a separate switch may be provided so that the operator can exit out of the options-setting mode whenever desired without having to go to the last option number.

Using the switches SW2, SW3 and SW4, the operator can set a variety of different options values for the possible options. The following chart provides an example of the relationship between the options and the option values, and is used by the operator to know which option values to use to program the TD 90.

| | POSSIBLE OPTION | |
|---|---|---|
| OPTION # | VALUE FOR “ZYX” | OPTION DESCRIPTION |
| 0 | 000-011 | Each digit can be set to 0 or 1 ONLY. |
| | | X digit: 0/1 = Disable/Enable random mode for Coin-In/Coin-Bet. |
| | | Y digit: 0/1 = Disable/Enable random mode for Coin-In/Coin-Bet. |
| | | Z digit: 0/1 = 2″/4″ ticket length. |
| 1 | 0-9 | X digit ONLY: Number of tickets to dispense when |
| | | Coin-In/Coin-Bet count reaches predetennined value. |
| 2 | 0-9 | X digit ONLY: Number of tickets to dispense when |
| | | Coin-Won count reaches predetermined value. |
| 3 | 0-9 | X digit ONLY: This value multiplied by 16 = number |
| | | of milliseconds waited before TDU is stopped. |
| 4 | 000-999 | This value multiplied by 20 to 25 = the number of |
| | | seconds the TDU waits to reset the count if no input |
| | | pulse is seen. Set to 0 to never reset. The maximum |
| | | possible time (non-zero) is 999x (20-25) = about 5.5 to 7 hours. |
| 5 | 0-9 | X digit ONLY: This is a multiplier value for multiplying the |
| | | values set in Option #1 and #2 to determine the total number of |
| | | tickets to be dispensed when the card is being used. |
| 6 | 0-9 | X digit ONLY: This is a multiplier value for multiplying the |
| | | values set in Option #1 and #2 to determine the total number of |
| | | tickets to be dispensed when the card is not being used. |
| 7 | 00-99 | YX digits ONLY: This value multiplied by 10 = number of |
| | | tickets needed in the ticket bin to turn on the “LOW BIN” LED. |
| | | For example, set this value to 5 to have the “LOW BIN” LED to |
| | | come on when the bin level is down to 50 tickets. |
| 8 | 000-999 | This value multiplied by 10 = number of tickets in a new stack of |
| | | tickets, e.g., sett to 100 for 1000 tickets. |
| 9 | 000-999 | In NON-RANDOM MODE: predetermined value to which |
| | | Coin-In/Coin-Bet count is compared to dispense tickets |
| | | In RANDOM MODE: Minimum count value for Coin-In/Coin-Bet. |
| A | 000-999 | In NON-RANDOM MODE: Not used. |
| | | In RANDOM MODE: Maximum count value for Coin-In/Coin-Bet. |
| B | 000-999 | In NON-RANDOM MODE: predetermined value to which Coin- |
| | | Won count is compared to dispense tickets. |
| | | In RANDOM MODE: Minimum count value for Coin-Won. |
| C | 000-999 | In NON RANDOM: Not used. |
| | | In RANDOM MODE: Maximum count value for Coin-Won. |
| D | 000-999 | The value multiplied by 10 = number of tickets presently in the ticket bin. |

As shown above, in the options-setting mode, the operator can set a variety of different parameters, such as the mode (e.g., CW Random mode) in which the TD 90 operates, various count and predetermined values that are used by the CPU 22 to determine whether a predetermined ticket dispensing event has occurred, the number of tickets to be dispensed when such event occurs, etc. These option values are used by the CPU 22 to implement the operation of the system 100.

In addition to setting the options, the operator can perform other operations to check the status of the TD 90, maintain the TD 90, add more tickets to the ticket bin, and investigate and correct errors.

For instance, if the operator desires to know how many tickets have been dispensed so far by the TDU 85, the operator can press the switch SW1 to begin the total ticket count display operation. This causes the first four digits of the total ticket count value to be displayed on the display unit 26. The total ticket count is a count of the number of tickets already dispensed by the TDU 85. If SW1 is pressed again, the last four digits of the total ticket count value will be displayed on the display unit 26. For instance, if the current total ticket count is “800”, then the display unit 26 will display “0000” when SW1 is pressed for the first time and then it will display “0800” when SW1 is pressed again. If, however, the display unit 26 is an 8-digit display (instead of 4-digits), then the operator will be able to view “00000800” by pressing SW1 once. Other variations are possible depending on the type of display unit used. If the operator presses SW1 again, then the normal operation will be resumed and the display unit 26 will be turned off.

The operator can also initiate the bin value update operation if he desires to update the memory or the CPU 22 after a new stack of tickets are loaded into the bin because the bin was low in tickets or tickets needed to be replaced. The number of tickets in a new stack that are being added to the bin can be entered in the options-setting mode (e.g., the option value for Option 8). When the number of tickets left in the current bin reaches a predetermined low level value set in the options-setting mode (e.g., the option value for Option 7), which causes the “Low Bin” LED to turn on, then the operator can press the reset switch SW_{R} to turn off the “Low Bin” LED. The pressing of the reset switch SW_{R} also causes the memory to be updated automatically based on the values that are set in the options-setting mode, so that the number of tickets in the bin now equals the number of tickets in the new stack plus the number of tickets that used to be in the bin.

When the operator replaces the existing tickets with a new stack of tickets entirely, the operator can press the switch SW1 twice which will cause the last four digits of the total ticket count to be displayed on the display unit 26 as discussed above. Then the operator can press the switch SW4 which will cause the memory to be updated so that the total number of tickets in the bin now equals the number of tickets in the new stack. The system will automatically turn off the “Low Bin” LED thereafter.

In accordance with one embodiment, the TD 90 is configured to enter into a help mode on two occasions.

1) If the TD 90 detects a problem with the TDU 85, the TD 90 enters the help mode wherein the help-mode LED is flashed and the TDU 85 is turned off; or

2) If the CPU 22 detects a problem with storing data in memory, the help-mode and “Low Bin” LEDs will alternately flash and the TD 90 will be halted. The operator can press the help switch SW_{H} to exit out of the help mode, e.g., when the problem has been fixed.

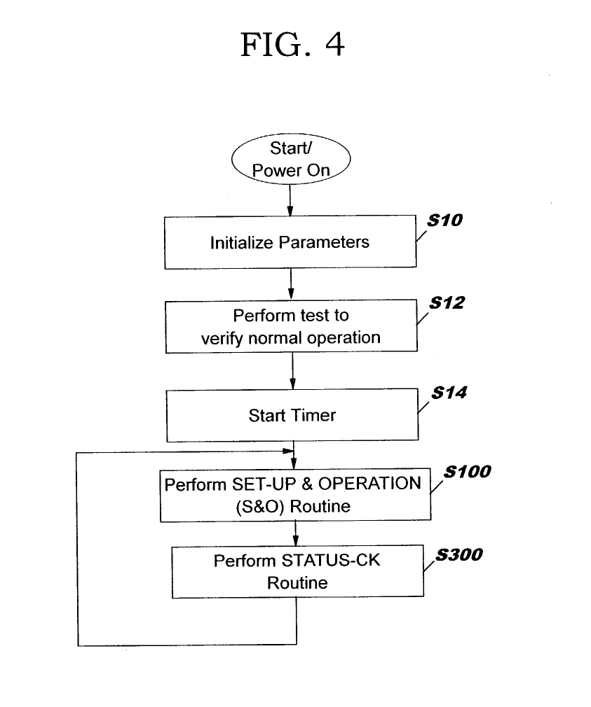

FIG. 4 is a flowchart illustrating the processing steps of the TD 90 according to one embodiment of the present invention. It should be clearly understood that these steps are computer-implemented steps and are preferably executed by the CPU 22 or microprocessor 34.

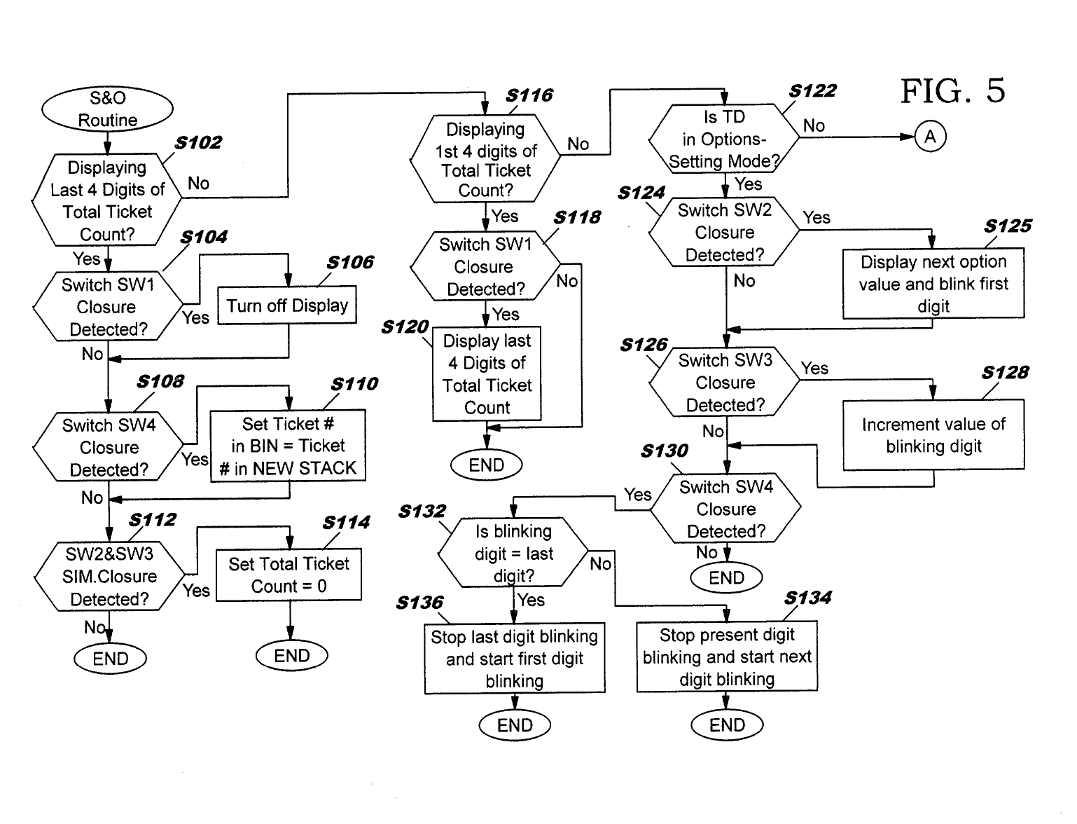

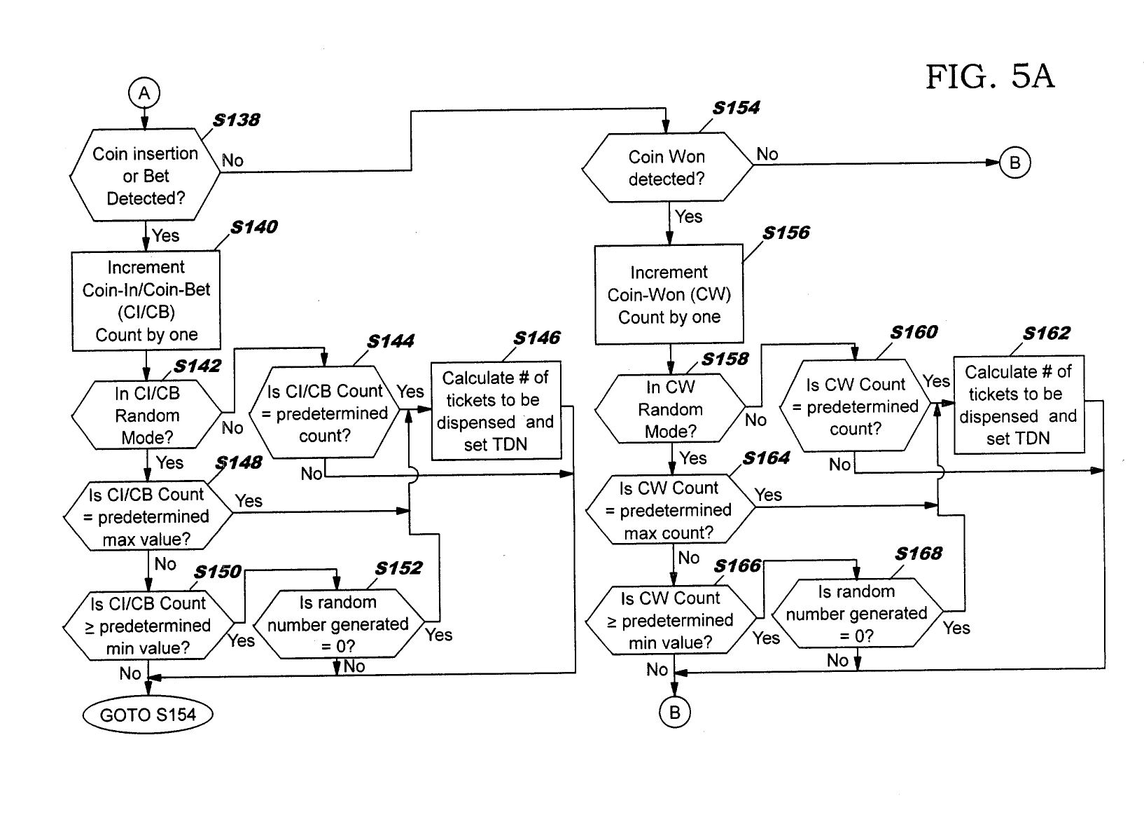

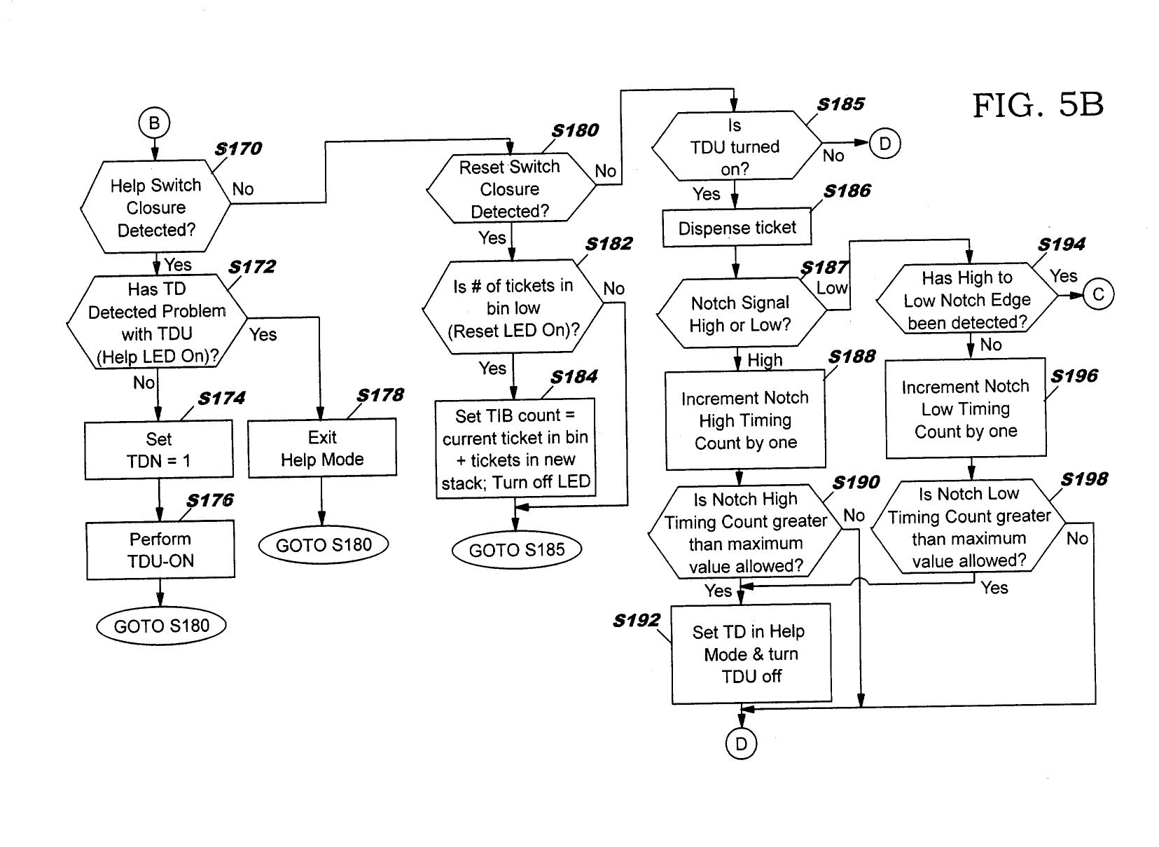

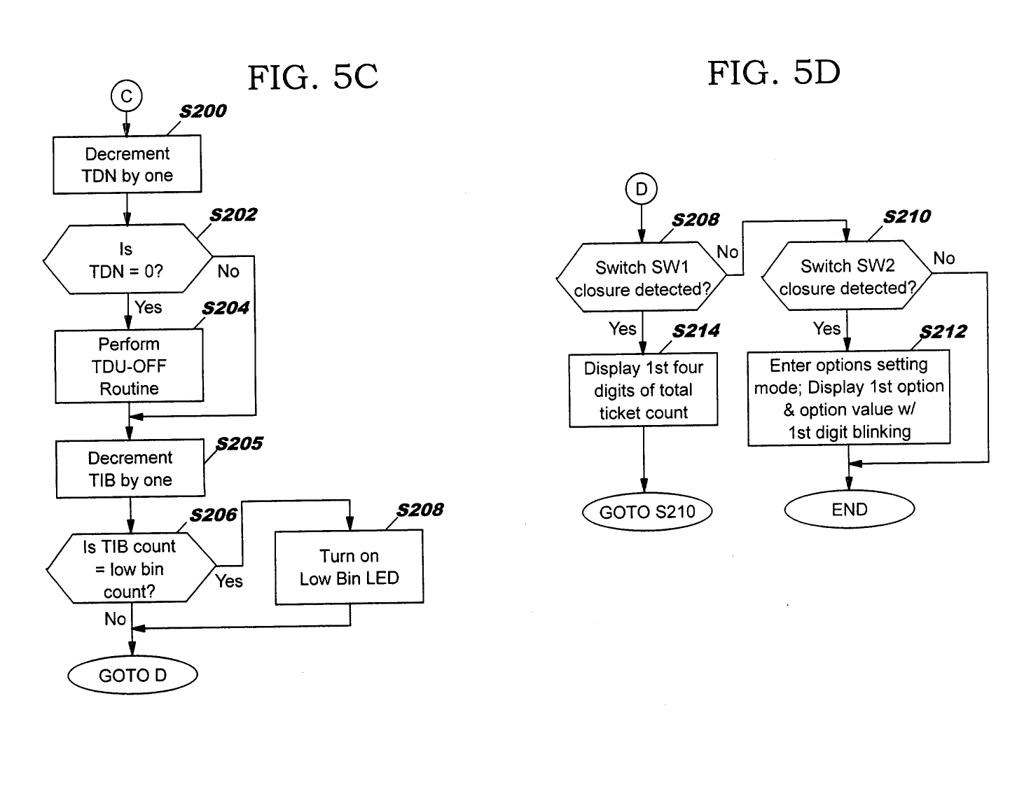

As shown in FIG. 4, when the TD 90 is turned on, the CPU 22 initializes all parameters such as RAM values in Step S10. In Step S12, certain tests are performed to determine if an error is detected during the last power outage. If an error is detected, then the CPU 22 controls the LEDs 84 to start blinking, indicating an error. If no error is detected, then a Loop time value is set to a predetermined value, e.g., one millisecond, and the Loop timer is started in Step S14. Then in Step S100, a Set-up and Operation (S&O) routine is performed. This routine involves setting up and operating the TD 90 as discussed above. A detailed description of the specific steps involved in the S&O routine will be described later in connection with FIGS. 5, 5A, 5B, 5C and 5D.

After Step S100 is completed, a Status Check (Status-CK) routine is performed in Step S300. The Status-CK routine monitors the status of certain components (e.g., relay) of the TD 90. At the end of Step S300, the Loop time will generally reach 0 and the Loop time will be reset to the predetermined loop value. Then the process loops back to Step S100, and Steps S100 and S30 are executed again. In this manner, the CPU 22 repeatedly executes Steps S100 and S300 including all the sub-steps involved therein, which will be discussed below. In a preferred embodiment, the Loop time (time allotted to loop through Steps S100 and S300) is set to one millisecond. This means the CPU 22 (or microprocessor 34) completes each one loop (Steps S100 and S300 including all the sub-steps) in about 1 millisecond, that is, almost instantaneously.

FIG. 5 is a flowchart illustrating the processing steps of the S&O routine executed in Step S100 of FIG. 4 according to one embodiment of the present invention. The S&O routine checks for any inputs from the operator and controls the components of the TD 90 in response to the operator inputs. It also determines whether a predetermined ticket dispensing event has occurred and controls the TDU 85 to dispense tickets upon the occurrence of the event. As mentioned above, it should be clearly understood that all the processing steps of the S&O are executed by the CPU 22 almost instantaneously (e.g., in about or less than 1 millisecond) and that the CPU 22 continuously loops through these steps because of the loop in FIG. 4.

As shown in FIG. 5, the CPU 22 determines whether the last four digits of the total ticket count is currently being displayed on the display unit 26 in Step S102. The total ticket count is a count of the number of tickets dispensed by the TDU 85. If this determination result is yes, it is determined whether the switch SW1 closure is detected in Step S104. That is, the CPU 22 determines if the switch SW1 has been pressed. If it has been, the display unit 26 is turned off in Step S106. If the switch SW1 closure is not detected, however, it is determined whether a closure of the switch SW4 is detected in Step S108. If the switch SW4 closure is detected, in Step S110 the number of total tickets in the bin is set to the number of tickets in a new stack which is set in Option 8.

If Step S108 determines that the switch SW4 is not closed, it is determined whether the switches SW2 and SW3 are simultaneously closed in Step S112. If yes, then the total ticket count (stored in memory) is set to zero in Step S114. After Steps S112 and S114, the process ends.

However, if the determination result at Step S102 is no, it is determined whether the first four digits of the total ticket count is displayed on the display unit 26 in Step S116. If it is, then a determination is made whether or not the closure of the switch SW1 is detected in Step S118. If the determination result at Step S118 is no, the process ends. However, if the determination result at Step S118 is yes, the CPU 22 controls the display unit 26 to display the first four digits of the total ticket count in Step S120 and the process ends.

If the determination result at Step S116 is no, the CPU 22 determines whether or not the TD 90 is in the options-setting mode in Step S122. If it is, a determination is made whether or not the switch SW2 is closed in Step S124. If the switch SW2 is detected to be closed (indicating that the operator has accepted the current option value), the next option value is displayed with the first digit blinking (i.e, “X” digit in “ZYX” option value) in Step S126. If the closure of the switch SW2 is not detected at Step S124, a determination is made in Step S126 whether or not the closure of the switch SW3 is detected. If yes, the value of the blinking digit of the option value is incremented by one in Step S128. At this time, if the value of the blinking digit is at a maximum value (e.g., 9), then the value of the blinking digit is set to a minimum value (e.g., 0). If the closure of the switch SW 3 is not detected at Step S126, it is determined whether or not the closure of the switch SW4 is detected in Step S130. If no, then the process ends. But, if the closure of the switch SW4 is detected, a determination is made whether or not the blinking digit is the last digit (e.g., “Z” digit in “ZYX” option value) in Step S132. If it is not, then the blinking of the present digit is stopped and the next digit begins blinking in Step S134 and the process ends. If, however, the determination result at Step S132 is yes, indicating that the current blinking digit is the last digit, then the blinking of the last digit is stopped and the first digit (i.e., “X” digit) begins to blink, and the process ends.

Accordingly, Steps S102-S120 implement the total ticket count display operation and the bin value update operation requested by the operator by pressing certain switches as discussed above, and Steps S122-S134 implement the options-setting process initiated by the operator using the switches SW2-SW4 as discussed above.

FIG. 5A is a flowchart illustrating the processing steps of Part A shown in FIG. 5 according to one embodiment of the present invention. These steps are executed by the CPU 22 as part of the S&O routine, typically in less than 1 ms.

As shown in FIG. 5A, it is determined whether a coin insertion or coin betting is detected in Steps S138 if the determination result at Step S122 (FIG. 5) is no, indicating that the TD 90 is not in the options-setting mode. This determination can be made based on the output signals (e.g., Coin-In/Coin-Bet signals) of the slot machine 10. If a coin insertion or coin betting is detected, then a Coin-In/Coin-Bet (CI/CB) count is incremented by one in Step S140. In Step S142, it is determined whether the TD 90 is in the CI/CB Random Mode in Step S142. If it is not, indicating that the system is in the CI/CB Non-Random Mode, it is determined whether the CI/CB count equals a predetermined count value for winning tickets in Step S144. This predetermined count value is set in the options-setting mode, e.g., the option value of Option 9. If the determination result at Step S144 is yes, the CI/CB count is reset to 0, a total number of tickets to be dispensed by the TDU 85 is calculated (e.g., by multiplying the option value of Option 1 by the option value of Option 5), and a ticket dispensing number (TDN) is set to the calculated value in Step S146. The TDU 85 dispenses tickets according to the TDN. For example, if the TDN is set to 15, then the TDU 85 will dispense 15 tickets at one time. If the determination result at Step S144 is no or Step S146 is completed, the process proceeds to Step S154 discussed below.

At Step S142, however, if it is determined that the TD 90 is in the CI/CB Random Mode, it is determined in Step S148 whether the CI/CB count equals a predetermined maximum count value set for this mode. The predetermined maximum count value is set during the options-setting mode, e.g., the option value of Option A. If the determination result at Step S148 is yes, the process proceeds to Step S146 discussed above. But, if the determination result at Step S148 is no, then it is determined in Step S150 whether the CI/CB count is equal to or greater than a predetermined minimum count value set for this mode. The predetermined minimum count value is set during the options-setting mode, e.g., the option value of Option 9. If the determination result at Step S150 is yes, it is determined whether a current random number generated by the CPU 22 equals a predetermined number (e.g., 0) in Step S152. Here, the use of 0 as the predetermined number is preferred because it provides higher probability of tickets being dispensed by the TDU 85. If the random number equals 0, then the process proceeds to Step S146 whereby the tickets will be dispensed; otherwise, the process proceeds to Step S154.

At Step S138, if it is determined that a coin insertion or coin betting is not detected, then it is determined whether a coin is won by a player in Step S154. This detection can be made based on the output signals (e.g., Coin-Won signals) of the slot machine 10. If a coin is won, then a Coin-Won (CW) count is incremented by one in Step S156. In Step S158, it is determined wether the TD 90 is in the CW Random Mode. If it is not, indicating that the system is in the CW Non-Random Mode, it is determined in Step S160 whether the CW count equals a predetermined count value for winning tickets. This predetermined count value is set in the options-setting mode, e.g., the option value of Option B. If the determination result at Step S160 is yes, the CW count is reset to 0, a total number of tickets to be dispensed by the TDU 85 is calculated (e.g., by multiplying the option value of Option 2 by the option value of Option 5), and the TDN is set to the calculated value in Step S162. If the determination result at Step S160 is no or Step S162 is completed, the process proceeds to Part B discussed below.

At Step S158, however, if it is determined that the TD 90 is in the CW Random Mode, it is determined in Step S164 whether the CW count equals a predetermined maximum count value set for this mode. The predetermined maximum count value is set during the options-setting mode, e.g., the option value of Option C. If the determination result at Step S164 is yes, the process proceeds to Step S162 discussed above. But, if the determination result at Step S164 is no, then it is determined in Step S166 whether the CW count is equal to or greater than a predetermined minimum count value set for this mode. The predetermined minimum count value is set during the options-setting mode, e.g., the option value of Option B. If the determination result at Step S166 is yes, it is determined whether a current random number generated by the CPU 22 equals a predetermined number (i.e., 0) in Step S168. If the random number equals 0, then the process proceeds to Step S162 whereby the tickets will be dispensed; otherwise, the process proceeds to Part B.

Accordingly, the processing steps of Part A determine the current mode of the TD 90 as set by the operator in the options-setting mode, determine whether a particular ticket dispensing event according to that mode has occurred, and set the TDN appropriately for dispensing tickets upon the occurrence of such event.

FIG. 5B is a flowchart illustrating the processing steps of Part B of FIG. 5A according to one embodiment of the present invention. These processing steps are executed by the CPU 22 as part of the S&L routine.

As shown in FIG. 5B, a determination is made in Step S170 whether or not the help switch SW_{H} is pressed by the operator if a coin is not won (Step S154 in FIG. 5A) or Step S160, 162 or 166 has been completed. The operator can press the help switch SW_{H} if he wants to exit out of the help mode after the problem of the TDU 84 has been fixed, or if he has added new tickets in the bin and wants to confirm that the TDU 85 is operating properly, i.e., wants to test dispensing of few tickets.

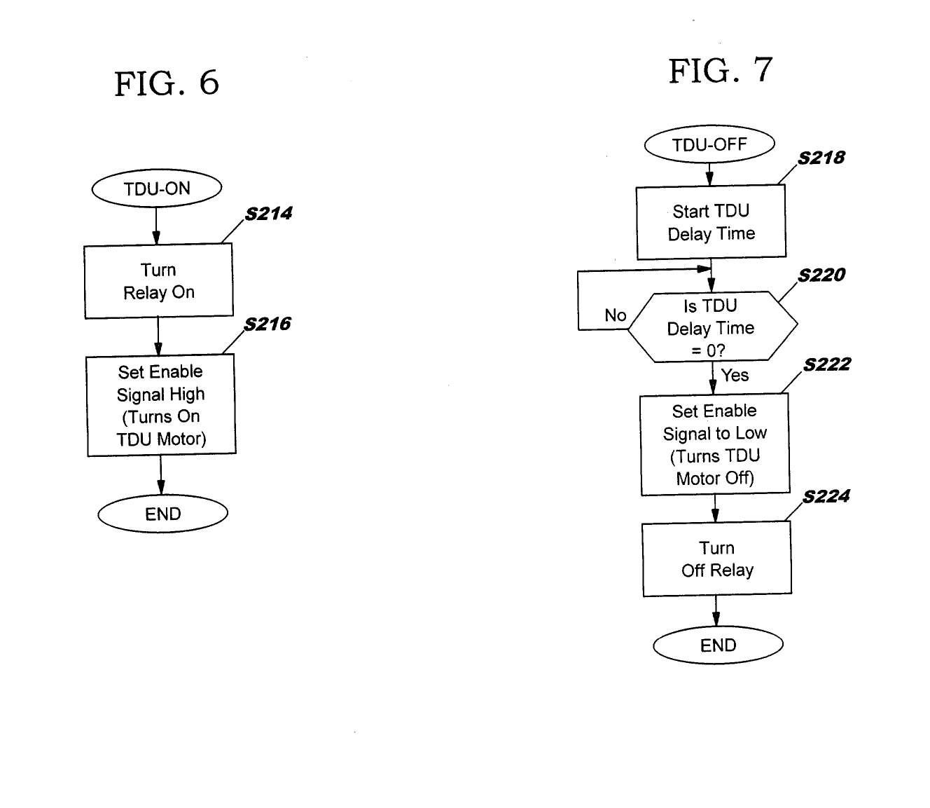

If the help switch SW_{H} has been pressed, it is determined in Step S172 whether the problem of the TDU has been already detected (e.g., by determining whether the help-mode LED is turned on). If yes, this indicates that the operator has already fixed the problem and now wants to exit the help mode. Thus, the TD 90 exits out of the help mode, turns off the help-mode LED and returns to the normal operation mode in Step S178. Then the process goes to Step S180. But, if the determination result at Step S172 is no, then in Step S174, the TDN is set to 1 or some other number so that the dispensing of one or few new tickets can be tested subsequently. To test the dispensing of new tickets, a Ticket Dispensing Unit—Turn On (TDU-ON) routine is performed. This routine is discussed later in connection with FIG. 6 and is used to turn on the TDU 85 so that tickets can be dispensed. After Step S176, the process proceeds to Step S180.

If the closure of the help switch SW_{H} is not detected at Step S170, it is determined whether the closure of the reset switch SW_{R} is detected in Step S180. If it is, it is determined in Step 182 whether or not the number of tickets in the bin is less than a predetermined value indicating low bin. If yes, then the number of tickets in the bin is set to equal the current number of tickets present in the bin plus the number of tickets in a new stack, and the help-mode LED is turned off in Step S184.

If the determination result at Step S182 or S180 is no, or Step S184 is completed, the process moves on to Step S185. In Step S185, it is determined whether or not the TDU 85 is turned on. If it is not, then the process proceeds to Part D, but if it is, then the CPU 22 instructs the TDU 85 to dispense a ticket in Step S186, e.g., by generating a control signal corresponding to the TDN. Then a notch signal is examined to verify that a ticket has been dispensed. Other means are available to verify proper ticket dispensing. A notch signal detects a notch between two adjacent tickets. In this example, a high notch signal corresponds to a notch area and a low notch signal corresponds to a non-notch area of a ticket. Thus, a low-high-low level transition in the notch signal represents a detection of a notch, indicating a ticket has been dispensed. Accordingly, in Step S187, it is determined whether a notch signal is high or low. If the notch signal is low, it is determined in Step S194 whether a high-to-low transition in the notch signal has occurred. If it has, then it indicates that a ticket has been properly dispensed and the process proceeds to Part C discussed below. However, if such a high-to-low transition is not detected in the notch signal, then a Notch Low Timing count is incremented by one in Step S196. This count indicates how long the notch signal has been at a low level. Then in Step S198, it is determined whether the Notch Low Timing count is greater than a predetermined value. If it is, indicating that there is a problem with the TDU 85 (e.g., ticket jam, etc.), then in Step S192, the system enters the help mode and the help-mode LED is turned on and the TDU 85 is turned off. Thereafter, the process proceeds to Part D discussed below.

At Step S187, however, if it is determined that the notch signal is at a high level, then a Notch High Timing count is incremented by one in Step S188. In Step S190, it is determined if the Notch High Timing count is greater than a predetermined value. If it is, then Step S192 discussed above is performed but, if it is not, then the process proceeds to Part D. Accordingly, Steps S170-S184 implement the help-mode and reset operations discussed above and Steps S185-S198 cause dispensing of tickets and verification of the proper operation of the TDU 85.

FIG. 5C is a flowchart illustrating the processing steps of Part C shown in FIG. 5B according to one embedment of the present invention. These steps are executed by the CPU 22 as part of the S&O routine. As shown in FIG. 5C, in Step S200 the system decrements the TDN (ticket dispensing number) by one since a ticket has been successfully dispensed in previous Step S186. Then in Step S202, it is determined if the current TDN equals zero. If it is not, then Step S205 is performed. But, if it is, a Ticket Dispensing Unit—Turn Off (TDU-OFF) routine is performed in Step S204 wherein the TDU 85 will be turned off In Step S205, the count of number of tickets in the bin (TIB count) is decremented by one (since a ticket has been dispensed from the bin). In Step S206, it is determined whether the current TIB count is equal to a low bin count value set in the options-setting mode (e.g., the option value of Option 7). If it is, the “Low Bin” LED is turned on in Step S208. Thereafter, the process proceeds to Part D.

Accordingly, the processing steps of Part C are used to decrement the TDN count by one each time a ticket is dispensed so that only the desired number of tickets are dispensed, and to turn off the TDU 85 when the desired number of tickets has been dispensed.

FIG. 5D is a flowchart illustrating the processing steps of Part D according to one embodiment of the present invention. These steps are executed by the CPU 22 as part of the S&O routine. As shown in FIG. 5D, Part D begins with Step S208 which detects whether or not the switch SW1 has been pressed. If it is not, it is determined whether or not the switch SW2 has been pressed in Step S210. If the switch SW2 has not been pressed, the process ends. But if the switch SW2 has been pressed, the system enters the options-setting mode in Step S212 wherein the first option and the associated option value are displayed on the display unit 26 with the first digit of the option value blinking. Then Part D process ends. However, at Step S208, if it is determined that the switch SW1 has been pressed, the first four digits of the total ticket count value is displayed on the display unit 26 and the process moves to Step S210 discussed above.

Accordingly, Steps S208 and S214 implement a part of the total ticket count display operation initiated by the operator and Steps S210 and S212 implement a beginning part of the options-setting mode discussed above.

FIG. 6 is a flowchart illustrating the processing steps of the TDU-ON routine executed in the S&O routine according to one embodiment of the present invention. The TDU-ON routine turns on the TDU 85. More particularly, as shown in FIG. 6, the TDU-ON routine involves turning on the relay 32 in Step S214 to provide power to the TDU 85. Then the system awaits a certain period of time for the TDU 85 to stabilize and then a TDU motor (motor in the TDU) is enabled or turned on by setting an Enable signal high. The TDU 85 is now turned on and this process ends.

FIG. 7 is a flowchart illustrating the processing steps of the TDU-OFF routine executed in the S&O routine according to one embodiment of the present invention. The TDU-OFF routine turns off the TDU 85. More particularly, as shown in FIG. 7, the TDU-OFF routine begins by starting or running a TDU Delay Time in Step S218. A TDU Delay Time is a delay time allotted to ensure that the TDU 85 completes the ticket dispensing process before the system turns off the TDU motor. In Step S220, it is determined whether the current TDU Delay Time equals zero (i.e., whether the waiting time has expired) This is checked until the current TDU Delay Time reaches zero at which time the Enable signal is set to a low level which causes the TDU motor to turn off in Step S222. Thus, the TDU 85 is now turned off. Then in Step S224, after the system waits a certain period of time to ensure that the TDU 85 is properly turned off, the relay 32 is turned off to remove power from the TDU 85 and the process ends.

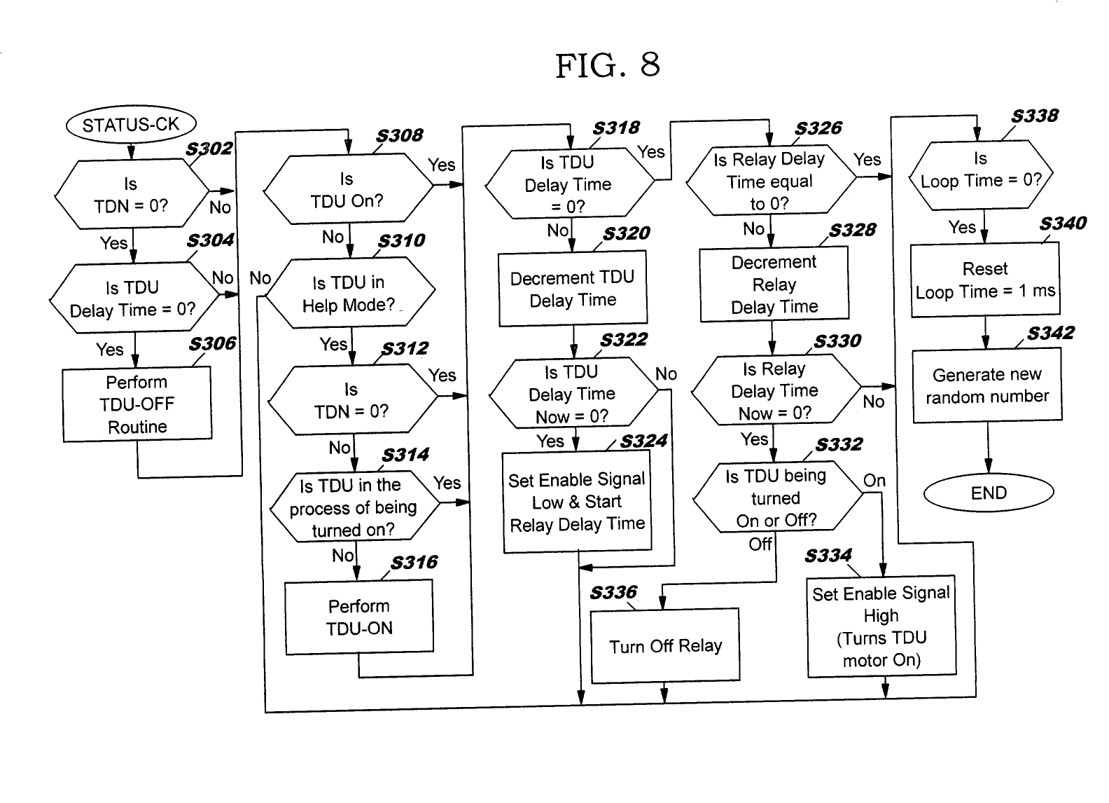

FIG. 8 is a flowchart illustrating the processing steps of the Status-CK routine shown in FIG. 4 according to one embodiment of the present invention. These steps are executed by the CPU 22 as part of the loop in FIG. 4 and thus, all the steps are executed almost instantaneously (e.g., in less than 1 millisecond).

As shown in FIG. 8, in Step S302, it is determined whether or not the TDN (total number of tickets to be dispensed by the TDU) equals zero. If it is, indicating no ticket should be dispensed now, it is determined whether the TDU Delay Time equals zero in Step S304. If it is, the TDU-OFF routine is performed in Step S306. This ensures that the TDU 85 is actually turned off. If the determination result at Step S302 or S304 is no, or the TDU-OFF routine is completed in Step S306, then Step S308 is performed. In Step S308, it is determined whether the TDU 85 is turned on. If it is not turned on, it is determined whether the TDU 85 is in the help mode in Step S310. If it is, it is determined whether the TDN is equal to zero in Step S312. If it is not, it is determined whether the TDU 85 is in the process of being turned on in Step S314. If it is not, the TDU-ON routine is executed in Step S316. If the determination result of Step S308, S312 or S314 is yes, or Step S316 is completed, then Step S318 is performed. However, if the determination result of Step S310 is no, the process proceeds to S338 discussed below.

In Step S318, it is determined whether the TDU Delay Time is equal to zero. If it is not, the TDU Delay Time is decremented in Step S320. Then it is determined whether the TDU Delay Time is now equal to zero in Step S322. If it is, the Enable signal is set to a low level, thereby turning off the TDU motor, and then a Relay Delay Time is started in Step S324. A Relay Delay Time is a certain time duration that the system awaits before it turns off the relay 32. This ensures that the system removes power from the TDU 85 only after all the operations of the TDU 85 have been completed or stopped.

At Step S318, if the determination result is yes, it is determined whether the Relay Delay Time equals zero in Step S326. If it is not, the Relay Delay Time is decremented in Step S328. Then it is determined whether the Relay Delay Time is now equal to zero in Step S330. If it is, it is determined whether the TDU 85 is in the process of being turned on or off in Step S332. If the TDU 85 is in the process of being turned on, the Enable signal is set to a high level in Step S334, causing the TDU motor to turn on, and the process proceeds to Step S338. However, if it is determined that the TDU 85 is in the process of being turned off at Step S332, the relay 32 is turned off in Step S336 and the process proceeds to Step S338.

In Step S338, it is determined whether the Loop time (loop of Steps S100 and S300 in FIG. 4), e.g., 1 millisecond, has reached zero in Step S338. This determination is repeated until the Loop time actually reaches zero. Then, the Loop timer is reset to a predetermined loop number, e.g., 1 millisecond, in Step S340. This enables the microprocessor 34 to function in a synchronized manner. Thereafter, a new random number is generated in Step S342, which is used in the Random modes. Then the Status-CK routine ends.

Accordingly, Steps S302-S336 check the status of the turn-on or turn-off process of the TDU 85 and ensure that the TDU 85 is properly turned on or turned off. This minimizes the occurrence of errors and malfunctions. Steps S338-S340 are used to synchronize the looping process in FIG. 4 and Step S342 is used to provide a new random number at the end of each loop process in FIG. 4 for use in the Random modes as needed.

Thus, the present invention provides a programmable ticket dispenser capable of being integrally coupled with a slot machine. The ticket dispenser dispenses tickets when certain predetermined ticket dispensing events occur. These tickets function as an incentive to the players of the slot machine to continue to play the game because the tickets can be redeemed for prizes, free games, or other reward-related purpose. Furthermore, the ticket dispenser of the present invention utilizes preexisting outputs signals typically generated by conventional electronic slot machines to trigger the dispensing of tickets. Thus, with minimal modification, the ticket dispenser can be coupled with any existing slot machine or be manufactured as part of the slot machine easily, thereby providing a gaming system that is simple, effective, and easy to install.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A method of providing an incentive for continued use of a slot machine, the method comprising the steps of:
providing a ticket dispenser integrally coupled with the slot machine;
monitoring output signals of the slot machine;
determining the occurrence of predetermined reward dispensing events based on the results of said monitoring step; and
dispensing tickets by the ticket dispenser upon the occurrence of the predetermined reward dispensing events.

2. The method of claim 1, wherein, in the monitoring step, the output signals include at least one of the following:
Coin-In signals indicating a number of coins inserted into the slot machine;
Coin-Bet signals indicating a number of coins bet in the slot machine;
Coin-Won signals indicating a number of coins won from using the slot machine; and
Card-In signals indicating a presence of a player tracking card in the slot machine.

3. The method of claim 1, wherein, in the providing step, the ticket dispenser is programmable by an operator such that the predetermined reward dispensing events can be modified.

4. The method of claim 1, wherein, in the providing step, the ticket dispenser is programmable using a plurality of switches and a display unit incorporated with the ticket dispenser.

5. The method of claim 1, wherein, in the determining step, the predetermined reward dispensing events include at least one of the following:
a first event wherein the total number of coins inserted or bet in the slot machine reaches a predetermined count value;
a second event wherein the total number of coins inserted or bet in the slot machine reaches a predetermined maximum count value, or the total number of coins inserted or bet in the slot machine is equal to or greater than a predetermined minimum count value but less than the predetermined maximum count value and a random number currently generated by the ticket dispenser equals a predetermined comparison value;
a third event wherein the total number of coins won from using the slot machine reaches a predetermined count value; and
a fourth event wherein the total number of coins won from using the slot machine reaches a predetermined maximum count value, or the total number of coins won is equal to or greater than a predetermined minimum count value but less than the predetermined maximum count value and a random number currently generate by the ticket dispenser equals a predetermined comparison value.

6. The method of claim 1, wherein the dispensing step includes:
detecting whether a player tracking card is present in the slot machine based on the output signals of the slot machine;
multiplying a predetermined number of tickets to be dispensed by a first number if the player tracking card is present;
multiplying the predetermined number of tickets to be dispensed by a second number if the player tracking card is not present; and
dispensing the tickets according to the results of said multiplying steps.

7. The method of claim 1, further comprising:
displaying the first four digits of a total ticket count in response to a first selection of a designated switch in the ticket dispenser, the total ticket count being a count of the number of tickets dispensed by the ticket dispenser; and
displaying the second four digits of the total ticket count in response to a second selection of the designated switch after the first selection.

8. The method of claim 1, wherein, in the determining step, the predetermined reward dispensing events include at least one of the following:
one event wherein the total number of coins inserted or bet in the slot machine reaches a predetermined maximum count value, or the total number of coins inserted or bet in the slot machine is equal to or greater than a predetermined minimum count value but less than the predetermined maximum count value and a random number currently generated by the ticket dispenser equals a predetermined comparison value; and
another event wherein the total number of coins won from using the slot machine reaches a predetermined maximum count value, or the total number of coins won is equal to or greater than a predetermined minimum count value but less than the predetermined maximum count value and a random number currently generate by the ticket dispenser equals a predetermined comparison value.

9. A ticket dispenser capable of being integrally coupled with a slot machine, for providing rewards to users of the slot machine, the ticket dispenser comprising:
an interface configured for receiving predetermined output signals from the slot machine, determining the occurrence of predetermined reward dispensing events based on the output signals, and generating control signals based on this determination results; and
a ticket dispensing unit for dispensing tickets responsive to the control signals.

10. The ticket dispenser of claim 9, wherein the predetermined output signals include at least one of the following:
Coin-In-signals indicating a number of coins inserted into the slot machine;
Coin-Bet signals indicating a number of coins bet in the slot machine;
Coin-Won signals indicating a number of coins won from using the slot machine; and
Card-In signals indicating a presence of a player tracking card in the slot machine.

11. The ticket dispenser of claim 9, wherein the predetermined reward dispensing events include at least one of the following:
a first event wherein the total number of coins inserted or bet in the slot machine reaches a predetermined count value;
a second event wherein the total number of coins inserted or bet in the slot machine reaches a predetermined maximum count value, or the total number of coins inserted or bet in the slot machine is equal to or greater than a predetermined minimum count value but less than the predetermined maximum count value and a random number currently generated by the ticket dispenser equals a predetermined comparison value;
a third event wherein the total number of coins won from using the slot machine reaches a predetermined count value; and
a fourth event wherein the total number of coins won from using the slot machine reaches a predetermined maximum count value, or the total number of coins won is equal to or greater than a predetermined minimum count value but less than the predetermined maximum count value and a random number currently generate by the ticket dispenser equals a predetermined comparison value.

12. The ticket dispenser of claim 9, wherein the interface includes:
a display unit;
a display interface unit for controlling the display unit;
a central processing unit (CPU), including memory, for controlling the display interface unit and the ticket dispensing unit based on the output signals of the slot machine;
a plurality of switches for communicating operator inputs to the CPU; and
a relay for providing power to the ticket dispensing unit under control of the CPU.

13. The ticket dispenser of claim 12, wherein the interface is programmable using the plurality of switches, whereby the predetermined reward dispensing events can be modified.

14. The ticket dispenser of claim 12, wherein the interface determines whether a player tracking card is present in the slot machine based on the output signals of the slot machine, multiplies a predetermined number of tickets to be dispensed by a first number if the player tracking card is present, multiples the predetermined number of tickets to be dispensed by a second number if the player tracking card is not present, and controls the ticket dispensing unit to dispense tickets according to the multiplication results.

15. The ticket dispenser of claim 12, wherein the display unit displays first four digits of a total ticket count in response to a first selection of a designated one switch of the plurality of switches, and displays second four digits of the total ticket count in response to a second selection of the designated switch after the first selection, the total ticket count being a count of the number of tickets dispensed by the ticket dispensing unit.

16. The ticket dispenser of claim 9, wherein the predetermined reward dispensing events include at least one of the following:
one event wherein the total number of coins inserted or bet in the slot machine reaches a predetermined maximum count value, or the total number of coins inserted or bet in the slot machine is equal to or greater than a predetermined minimum count value but less than the predetermined maximum count value and a random number currently generated by the ticket dispenser equals a predetermined comparison value; and
another event wherein the total number of coins won from using the slot machine reaches a predetermined maximum count value, or the total number of coins won is equal to or greater than a predetermined minimum count value but less than the predetermined maximum count value and a random number currently generate by the ticket dispenser equals a predetermined comparison value.

17. A gaming system comprising:
a slot machine for generating predetermined output signals indicative of certain conditions; and
a ticket dispenser, operatively coupled with the slot machine, for receiving the output signals from the slot machine and dispensing tickets as rewards based on the output signals when predetermined reward dispensing events occur.

18. The system of claim 17, wherein the predetermined output signals include at least one of the following:
Coin-In signals indicating a number of coins inserted into the slot machine;
Coin-Bet signals indicating a number of coins bet in the slot machine;
Coin-Won signals indicating a number of coins won from using the slot machine; and
Card-In signals indicating a presence of a player tracking card in the slot machine.

19. The system of claim 17, wherein the predetermined reward dispensing events include at least one of the following:
a first event wherein the total number of coins inserted or bet in the slot machine reaches a predetermined count value;
a second event wherein the total number of coins inserted or bet in the slot machine reaches a predetermined maximum count value, or the total number of coins inserted or bet in the slot machine is equal to or greater than a predetermined minimum count value but less than the predetermined maximum count value and a random number currently generated by the ticket dispenser equals a predetermined comparison value;
a third event wherein the total number of coins won from using the slot machine reaches a predetermined count value; and
a fourth event wherein the total number of coins won from using the slot machine reaches a predetermined maximum count value, or the total number of coins won is equal to or greater than a predetermined minimum count value but less than the predetermined maximum count value and a random number currently generate by the ticket dispenser equals a predetermined comparison value.
the interface includes:

20. The system of claim 17, wherein the ticket dispenser comprises:
an interface configured for receiving the output signals from the slot machine, determining the occurrence of the predetermined reward dispensing events based on the output signals, and generating control signals based on this determination results; and
a ticket dispensing unit for dispensing tickets responsive to the control signals.

21. The system of claim 20, wherein the interface of the ticket dispenser includes:
a display unit;
a display interface unit for controlling the display unit;
a central processing unit (CPU), including memory, for controlling the display interface unit and the ticket dispensing unit based on the output signals of the slot machine;
a plurality of switches for communicating operator inputs to the CPU; and
a relay for providing power to the ticket dispensing unit under control of the CPU.

22. The system of claim 21, wherein the interface determines whether or not a player tracking card is present in the slot machine based on the output signals of the slot machine, multiplies a predetermined number of tickets to be dispense by a first number if the player tracking card is present, multiplies the predetermined number of tickets to be dispensed by a second number if the player tracking card is not present, and controls the ticket dispensing unit to dispense tickets according to the multiplication results.

23. The system of claim 21, wherein the display unit displays first four digits of a total ticket count in response to a first selection of a designated one of the plurality of switches, and displays second four digits of the total ticket count in response to a second selection of the designated switch after the first selection, the total ticket count is a count of the number of tickets dispensed by the ticket dispensing unit.

24. The system of claim 17, wherein the predetermined reward dispensing events include at least one of the following:
one event wherein the total number of coins inserted or bet in the slot machine reaches a predetermined maximum count value, or the total number of coins inserted or bet in the slot machine is equal to or greater than a predetermined minimum count value but less than the predetermined maximum count value and a random number currently generated by the ticket dispenser equals a predetermined comparison value; and
another event wherein the total number of coins won from using the slot machine reaches a predetermined maximum count value, or the total number of coins won is equal to or greater than a predetermined minimum count value but less than the predetermined maximum count value and a random number currently generate by the ticket dispenser equals a predetermined comparison value.

25. Computer program product embodied on computer readable media readable by a computer device of a ticket dispenser integrally coupled with a slot machine, for providing an incentive for continued use of the slot machine, the product comprising:
first computer-readable program code means for monitoring predetermined output signals of the slot machine, and determining the occurrence of predetermined reward dispensing events based on the outputs signals; and
second computer-readable program code means for controlling dispensing of tickets from the ticket dispenser upon the occurrence of the predetermined reward dispensing events.

26. The computer program product of claim 25, wherein the output signals include at least one of the following:
Coin-In signals indicating a number of coins inserted into the slot machine;
Coin-Bet signals indicating a number of coins bet in the slot machine;
Coin-Won signals indicating a number of coins won from using the slot machine; and
Card-In signals indicating a presence of a player tracking card in the slot machine.

27. The computer program product of claim 25, wherein the predetermined reward dispensing events include at least one of the following:
a first event wherein the total number of coins inserted or bet in the slot machine reaches a predetermined count value;
a second event wherein the total number of coins inserted or bet in the slot machine reaches a predetermined maximum count value, or the total number of coins inserted or bet in the slot machine is equal to or greater than a predetermined minimum count value but less than the predetermined maximum count value and a random number currently generated by the ticket dispenser equals a predetermined comparison value;
a third event wherein the total number of coins won from using the slot machine reaches a predetermined count value; and
a fourth event wherein the total number of coins won from using the slot machine reaches a predetermined maximum count value, or the total number of coins won is equal to or greater than a predetermined minimum count value but less than the predetermined maximum count value and a random number currently generate by the ticket dispenser equals a predetermined comparison value.

28. The computer program product of claim 25, wherein the first computer-readable program code means determines whether a player tracking card is present in the slot machine based on the output signals of the slot machine, multiplies a predetermined number of tickets to be dispense by a first number if the player tracking card is present, and multiplies the predetermined number of tickets to be dispensed by a second number if the player tracking card is not present, and wherein the second computer-readable program code means generates control signals to a ticket dispensing unit to dispense the tickets according to the multiplication results.

29. The computer program product of claim 25, wherein the first computer-readable program code means controls a display unit to display first four digits of a total ticket count in response to a first selection of a designated switch in the ticket dispenser and to display second four digits of the total ticket count in response to a second selection of the designated switch after the first selection, the total ticket count being a count of the number of tickets dispensed by the ticket dispenser.

30. The computer program product of claim 25, wherein the predetermined reward dispensing events include at least one of the following:
one event wherein the total number of coins inserted or bet in the slot machine reaches a predetermined maximum count value, or the total number of coins inserted or bet in the slot machine is equal to or greater than a predetermined minimum count value but less than the predetermined maximum count value and a random number currently generated by the ticket dispenser equals a predetermined comparison value; and
another event wherein the total number of coins won from using the slot machine reaches a predetermined maximum count value, or the total number of coins won is equal to or greater than a predetermined minimum count value but less than the predetermined maximum count value and a random number currently generate by the ticket dispenser equals a predetermined comparison value.
